(19) United States
(12) Patent Application Publication
(10) Pub. No.: US 2017/0011203 A1
(43) Pub. Date: Jan. 12, 2017

(54) ENCRYPTING DATA WITHIN A HOST IMAGE

(71) Applicant: Microsoft Technology Licensing, LLC, Redmond, WA (US)

(72) Inventors: Sayan Pathak, Bangalore (IN); Darshatkumar Shah, Bangalore (IN)

(21) Appl. No.: 14/792,337

(22) Filed: Jul. 6, 2015

(51) Int. Cl. G06F 21/10; G06F 21/62; G06F 21/60

(52) U.S. Cl. CPC G06F 21/10; G06F 21/602; G06F 21/6245; G06F 2221/0724

(57) ABSTRACT

Image-hosted data encryption implementations are presented that encrypt and decrypt data within a host image. A bit stream representing a data item and a host image are accessed. The host image has pixels which include one or more color channels that are represented by bits that are interpreted when the host image is rendered and other bits that are not interpreted when the host image is rendered. The bit stream is inserted into the host image by injecting bits into the bits of the one or more color channels not interpreted when the host image is rendered. In this way, the inserted data is not seen when the host image is rendered. Decryption involves extracting bits associated with a bit stream from the bits of the one or more color channels of the host image pixels not interpreted when the host image is rendered, and then reconstructing the bit stream.

### BACKGROUND

People often have applications on their home computers and mobile computing devices that send or receive images. Images input into these applications could have been taken using a cell phone or digital camera, received via social media applications, received in email, and so on. These images typically end up being stored in a discoverable location, such as a folder on their desktop or mobile device, such as in a pictures library.

At times, a user may want to display the stored images to friends and family (such as in a slideshow), or send them to another computing device. However, some of the images in the library may be considered personal by the user, who may want to limit the viewing of the images.

Steganography involves inserting a digital data item such as an image, audio, or text into another data item (often referred to a host) in a manner that the inserted data item is not readily detectable when the host data item is displayed or played. Thus, if a user wants to display or send images that include the aforementioned personal images, steganography methods could be employed to encrypt the personal images in an innocuous host image.

### SUMMARY

The image-hosted data encryption implementations described herein generally encrypt data within a host image. In one implementation, a bit stream representing a data item is accessed. In addition, a host image is accessed that has pixels which include one or more color channels that are represented by bits that are interpreted when the host image is rendered and other bits that are not interpreted when the host image is rendered. The bit stream is inserted into the host image by injecting bits thereof into the bits of the one or more color channels of the host image pixels not interpreted when the host image is rendered. In one implementation, a plurality of bit streams are accessed instead of just one with each representing a different data item. In this implementation, the plurality of bit streams are inserted into the host image by injecting bits thereof into the bits of the one or more color channels of the host image pixels not interpreted when the host image is rendered.

The image-hosted data encryption implementations described herein can additionally decrypt data previously inserted into a host image. In one implementation this is realized by accessing a host image that has pixels which include one or more color channels that are represented by bits that are interpreted when the host image is rendered and other bits that are not interpreted when the host image is rendered and which has at least one bit stream representing a data item that has been inserted into the host image by injecting bits thereof into the bits of the one or more color channels of the host image pixels not interpreted when the host image is rendered. Bits associated with at least one bit stream are then extracted from the bits of the one or more color channels of the host image pixels not interpreted when the host image is rendered. For each bit stream whose bits have been extracted, the extracted bits are arranged in an order which reconstructs the bit stream, and the data item associated with the bit stream is rebuilt.

It should be noted that the foregoing Summary is provided to introduce a selection of concepts, in a simplified form, that are further described below in the Detailed Description. This Summary is not intended to identify key features or essential features of the claimed subject matter, nor is it intended to be used as an aid in determining the scope of the claimed subject matter. Its sole purpose is to present some concepts of the claimed subject matter in a simplified form as a prelude to the more detailed description that is presented below.

### DESCRIPTION OF THE DRAWINGS

The specific features, aspects, and advantages of the disclosure will become better understood with regard to the following description, appended claims, and accompanying drawings where:

FIG. 1 is a diagram illustrating one implementation, in simplified form, of an image-hosted data encryption system for encrypting digital data within a host image.

FIG. 2 is a flow diagram illustrating one implementation of a process for encrypting digital data within a host image.

FIG. 3 is a flow diagram illustrating one implementation of a process for accessing a host image where a received pre-host image is transformed into the host image.

FIG. 4 is a flow diagram illustrating one implementation of a process for encrypting a plurality of bit streams representing multiple data items within a host image.

FIG. 5 is a diagram illustrating one implementation, in simplified form, of an image-hosted data decryption system for decrypting digital data previously inserted into a host image.

FIGS. 6A-B depict a flow diagram illustrating one implementation of a process for decrypting digital data previously inserted into a host image.

FIG. 7 is a diagram depicting a general purpose computing device constituting an exemplary system for use with the image-hosted data encryption implementations described herein.

### DETAILED DESCRIPTION

In the following description reference is made to the accompanying drawings which form a part hereof, and in which are shown, by way of illustration, specific versions in which image-hosted data encryption implementations can be practiced. It is understood that other implementations can be utilized and structural changes can be made without departing from the scope thereof.

It is also noted that for the sake of clarity specific terminology will be resorted to in describing the image-hosted data encryption implementations and it is not intended for these implementations to be limited to the specific terms so chosen. Furthermore, it is to be understood that each specific term includes all its technical equivalents that operate in a broadly similar manner to achieve a similar purpose. Reference herein to “one implementation”, or “another implementation”, or an “exemplary implementation”, or an “alternate implementation” means that a particular feature, a particular structure, or particular characteristics described in connection with the implementation can be included in at least one version of the image-hosted data encryption. The appearances of the phrases “in one implementation”, “in another implementation”, “in an exemplary implementation”, and “in an alternate implementation” in various places in the specification are not necessarily all referring to the same implementation, nor are separate or alternative implementations mutually exclusive of other implementations. Yet furthermore, the order of process flow representing one or more implementations of the project information extraction does not inherently indicate any particular order or imply any limitations thereof.

As utilized herein, the terms “component,” “system,” “client” and the like are intended to refer to a computer-related entity, either hardware, software (e.g., in execution), firmware, or a combination thereof. For example, a component can be a process running on a processor, an object, an executable, a program, a function, a library, a subroutine, a computer, or a combination of software and hardware. By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, to the extent that the terms “includes,” “including,” “has,” “contains,” and variants thereof, and other similar words are used in either this detailed description or the claims, these terms are intended to be inclusive in a manner similar to the term “comprising” as an open transition word without precluding any additional or other elements.

### 1.0 Image-Hosted Data Encryption

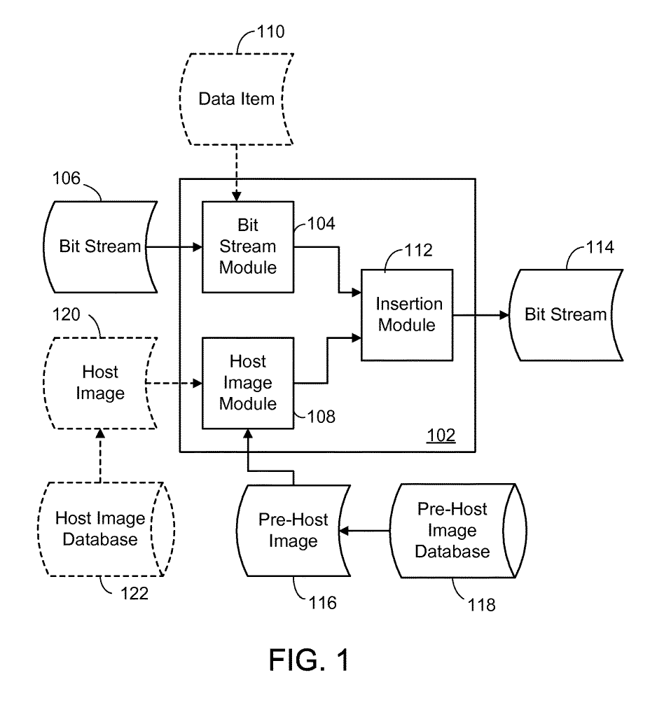

In general, the image-hosted data encryption implementations described herein encrypt digital data within a host image. Referring to FIG. 1, in one implementation, one or more computing devices each comprising a processor, communication interface and memory are employed. If multiple computing devices are being used, they are in communication with each other via a computer network. An image-based data encrypter computer program 102 having program modules executable by the computing device or devices is also employed. These program modules include a bit stream module 104 for accessing at least one bit stream each representing a data item that is to be encrypted within the host image. Also included is a host image module 108 for accessing the host image, as well as an insertion module 112 for inserting the bit stream (or streams) into the host image. The result is a modified host image 114 with the bit stream(s) encrypted therein.

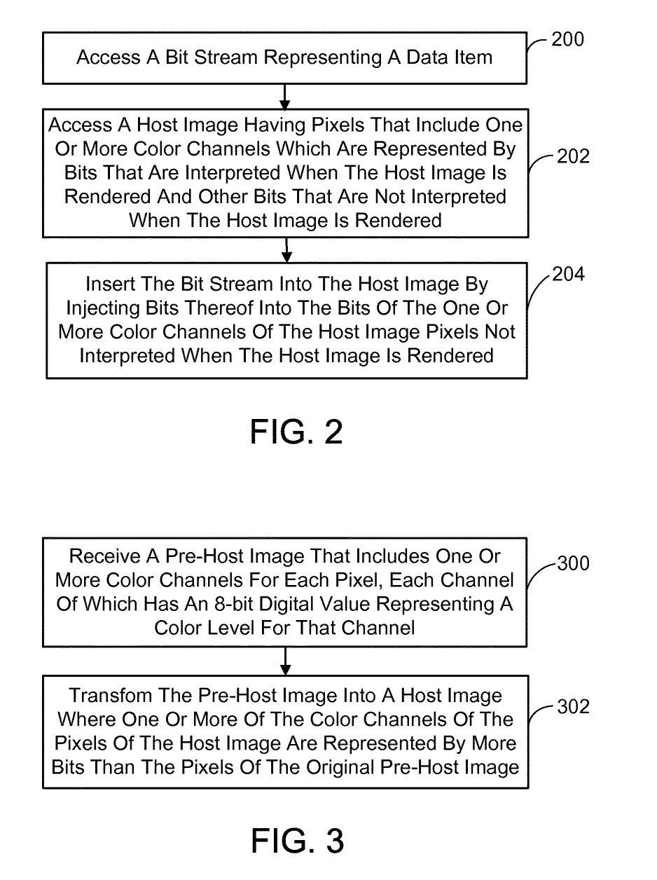

Referring now to FIG. 2, in view of the foregoing, in one general implementation the aforementioned modules access a bit stream representing a data item (action 200), and access a host image having pixels that include one or more color channels which are represented by bits that are interpreted when the host image is rendered and other bits that are not interpreted when the host image is rendered (action 202). The bit stream is then inserted into the host image by injecting bits thereof into the bits of the one or more color channels of the host image pixels not interpreted when the host image is rendered (action 204).

A data item encrypted within the host image can be any desired, such as, without limitation, image data, or audio data, or textual data, or any combination thereof. Generally, any type of data a user considers personal and does not want to be publically displayed or played can be encrypted within the host image. This includes personal data, business data, social data, financial data, and so on.

There are several advantages to encrypting digital data within a host image. For example, in the case of image data, because the bits of the data are injecting into the bits of the color channel(s) of the host image that are not interpreted when the host image is rendered, the image associated with the encrypted data is not seen. In this way, images that a user considers personal and does not want to publically display can be stored and retained, yet still kept secure. If the host image is intentionally (such as in a slideshow of stored images) or accidentally displayed, all that will be seen is the host image. Another advantage of encrypting image data in a host image involves watermarking. If the host image is an image a user wants to invisibly watermark so as to prove its source should the need arise, the image data encrypted within the host image could provide the desired proof. Of course, the watermark need not be just image data. Rather, it could be other types of data (e.g., audio, text, and so on), or a combination of different types of data.

The following sections will describe in more detail the encryption of the digital data within a host image; including accessing the bit stream and host image, and injecting the bit stream into the host image. In addition, the decryption and recovery of the encrypted data will be described.

### 1.1 Accessing the Bit Stream

A bit stream in the context of the image-hosted data encryption implementations described herein is a stream of digital values representing a data item that it is desired to encrypt into a host image, as well as ancillary information associated with the data item. For example, in the case where the data item is an image, the bit stream takes the form of pixel data, and optionally metadata such as height, width, format, and so on. As will be described in more detail later, the bit stream can also include encryption information.

Referring again to FIG. 1, in one implementation of image-hosted data encryption, the bit stream is pre-constructed, and accessing it simply involves retrieving the steam from a bit stream memory 106. However, in another implementation, accessing the bit stream involves receiving the data item from a data item memory 110 and generating a bit stream from the data item. It is noted that the data item memory 110 and its communication link to the bit stream module 104 is shown using dashed lines in FIG. 1 to indicate it is an alternate implementation.

In either implementation, there can be a question as to whether the bit stream will completely fit into the host image. More particularly, as indicated previously, the bits of the bit stream are placed into the bits of the pixel color channel(s) not interpreted when the host image is rendered. Thus, the total amount of available space in the upper order bits of the pixel color channels needs to be sufficient to accommodate all the bits of the bit stream. This can be handled in a variety of ways, some of which involve manipulating the bit stream itself.

For example, in one implementation where accessing the bit stream involves receiving a data item and generating the bit stream from the item, a portion of the data making up the data item can be removed prior to generating the bit stream (which would make the bit stream smaller owing to the removed data). The amount of data removed from the data item is enough to ensure the resulting data stream fits completely in the host image. In the case where the data item is an image, the removal of data can take the form of cropping a portion of the image.

In either of the bit stream accessing implementations, another way to reduce the size of the bit stream to ensure it fits into the host image is to compress the data using conventional data compression methods. It is noted that this compression alternative may include adding information to the bit stream that is subsequently used to decompress the stream when it is recovered from the host image.

### 1.2 Accessing the Host Image

A host image in the context of the image-hosted data encryption implementations described herein is a grayscale or color digital image. A grayscale image has one color channel per pixel, whereas a color image has three or more color channels per pixel. A host image is created from a standard (pre-host) image which in one implementation has an 8-bit (1 byte) digital value representing a color level for each color channel of each pixel of the image. These images are meant to be rendered for display by standard graphics hardware that reads (interprets) the 8-bit values associated with each color channel. The pre-host image can depict any scene desired. As will become clear shortly when a host image is rendered, all the 8-bit values associated with each color channel are read as they existed in the pre-host image. Thus, there is no distortion caused by the encrypted data inserted into the host image.

In general, the pre-host image is transformed into a host image by increasing the number of bits used to represent the color value in each pixel color channel. More particularly, extra upper order bits are added to each pixel color channel. Since standard graphics hardware will interpret only the first, lower order bits of each color channel for each pixel, the extra upper order bits are ignored. This allows bits from the previously-described bit stream to be injected into the added upper order bits without affecting the rendering of the lower order bits. Thus, the scene depicted in the pre-host image (and now the host image) is advantageously rendered without distortion. In this way there is no visible way to detect the encrypted data that has been injected into the host image.

In one implementation of image-hosted data encryption, the pre-host image is received and transformed into a host image. More particularly, referring to the process of FIG. 3, in action 300 a pre-host image (116 in FIG. 1) including one or more color channels for each pixel, each channel of which has an 8-bit digital value representing a color level for that channel, is received by the aforementioned image-based data encrypter computer program (102 of FIG. 1). In one version, this pre-host image comes from a pre-host image database (118 in FIG. 1). The pre-host image is selected by the image-based data encrypter computer program in one version. In another version, a user selects the pre-host image and sends it to the image-based data encrypter computer program (102 of FIG. 1). Next, in action 302 the received pre-host image is transformed into a host image where one or more of the color channels of the pixels of the host image are represented by more bits than the pixels of the original pre-host image. It is noted that the upper order bits represent the added bits and are not interpreted when the transformed image is rendered. This transformation is performed by the host image module (108 in FIG. 1).

While the number of added bits is not limited in any way, it is noted that too few added bits would limit the amount of data that could be encrypted in the host image. In addition, too many added bits could adversely affect the transmissibility of the host image over a network (such as the Internet or a proprietary intranet) in cases where bandwidth is restricted. In one implementation, the pre-host image is transformed into a JPEG-XR formatted image. The JPEG-XR format employs two bytes for each color channel of each pixel. More particularly, each color channel of the pixels of the JPEG-XR formatted host image has 8 bytes—2 for R (red color), 2 for G (green color), 2 for B (blue color), and 2 for A (alpha value).

As described previously, there can be a question as to whether the bit stream will completely fit into the host image. The total amount of available space in the upper order bits of the pixel color channel(s) of the host image needs to be sufficient to accommodate all the bits of the bit stream. As indicated, there are a variety of ways this situation can be handled. In an implementation where the pre-host image is received and transformed into a host image, it is possible to transform the received pre-host image into a host image that has a sufficient number upper order bits added to the color channel(s) of the pixels to allow insertion of the entirety of the data item bit stream in the added upper order bits. Another way to ensure a sufficient number upper order bits in the color channel(s) of the host image pixels to fit the bit stream involves scaling the host image up to increase the number of pixels to a sufficient number such that the color channel(s) have enough upper order bits to insert the entirety of the data item bit stream. This has the advantage of preserving the bit stream (and so data item) with full fidelity as well as reducing storage for the host image database. This is particularly relevant for systems with limited memory, such as mobile communication devices and the Internet of Things.

In one implementation of image-hosted data encryption, host images (120 in FIG. 1) are generated ahead of time and stored in a host image database (122 in FIG. 1). It is noted that the host image 120, host image database 122, and the communication links between them and to the host image module 108 are shown using dashed lines in FIG. 1 to indicate it is an alternate implementation. In the alternate implementation, accessing a host image 120 involves the image being selected from the host image database 122. In one version, the host image 120 is selected by the image-based data encrypter computer program (102 in FIG. 1). In another version, a user selects the host image 120 and sends it to the host image module 108.

In an implementation involving a database of host images, the question as to whether the bit stream will fit completely into the host image, can be handled in one version by selecting a host image that has a sufficient number of pixels with one or more of the color channels having upper order bits not interpreted when the host image is rendered to insert the entirety of the data item bit stream. If, however, no such host image is available, or the user selects a host image that has insufficient space, the aforementioned scaling technique can be employed. More particularly, the selected host image is scaled up to increase the number of pixels to a sufficient number having color channel(s) with upper order bits to insert the entirety of the data item bit stream.

1.3 Injecting Bits into the Host Image

As described previously, once the data item bit stream and host image have been accessed, the bit stream is inserted into the host image by injecting bits thereof into the upper order bits of the one or more color channels of the host image pixels that are not interpreted when the host image is rendered. More particularly, in one implementation, the bit stream is split into blocks of a size that that will fit in the upper order bits (e.g., those bits above the first 8 bits) of the pixel color channels of the host image. The existing upper level bits of a pixel color channel (which may be all zeros) are then overwritten with a block of the bit stream. In one version, the order in which the blocks are injected can be prescribed. For example, the first block of the bit stream can be injected into a pre-defined color channel of the first pixel of the host image, the second block into the next pre-defined color channel (if there is one) of the first pixel, and so on for each pixel in raster order. In the case where each pixel has multiple color channels, the aforementioned pre-defined order in which they are filled can be any desired (e.g., R, then G, then B, then A). The prescribed injection order facilitates the reading of the blocks and the reconstruction of the bit stream during decryption of the associated data item.

It is noted that while standard graphics hardware will interpret only the first, lower order 8-bits of each color channel for each pixel and ignore the upper order bits of a host image, it is still possible to detect and extract the upper order bits. It situations where it is desired to keep a data item associated with the bit stream injected into the upper order bits of the host images' pixel color channels private and secure (even if it is transmitted or shared), actions can be taken to further encrypt the bit stream. If such actions are taken, the data will remain secure even if the bits injected into the upper order bits of the color channels are detected and extracted.

More particularly, in one implementation, the aforementioned bit stream blocks are randomized prior to being injected in the host image color channels in the manner described above. A decrypting entity knows the randomization scheme so that the bit streams can be reconstructed. However, the randomization makes it difficult for an entity not knowing the randomization scheme to reconstruct the bit stream.

Further, in one implementation, the bit stream can be encrypted using conventional encryption methods. For example, in one version, the bit stream is encrypted using a symmetric encryption scheme and password protection. Thus, an entity can detect and extract the upper order bits, but without knowing the password cannot decrypt the encrypted bit stream. It is noted that in the context of the image-hosted data encryption implementations described herein the term password is used in a broad sense in that it can be alphanumeric or biometric or sensor-based, or so on. It is further noted that depending on the type of encryption scheme employed, the bit stream may be expanded to include encryption information needed to decrypt the stream.

1.4 Inserting Multiple Data Items into the Host Image

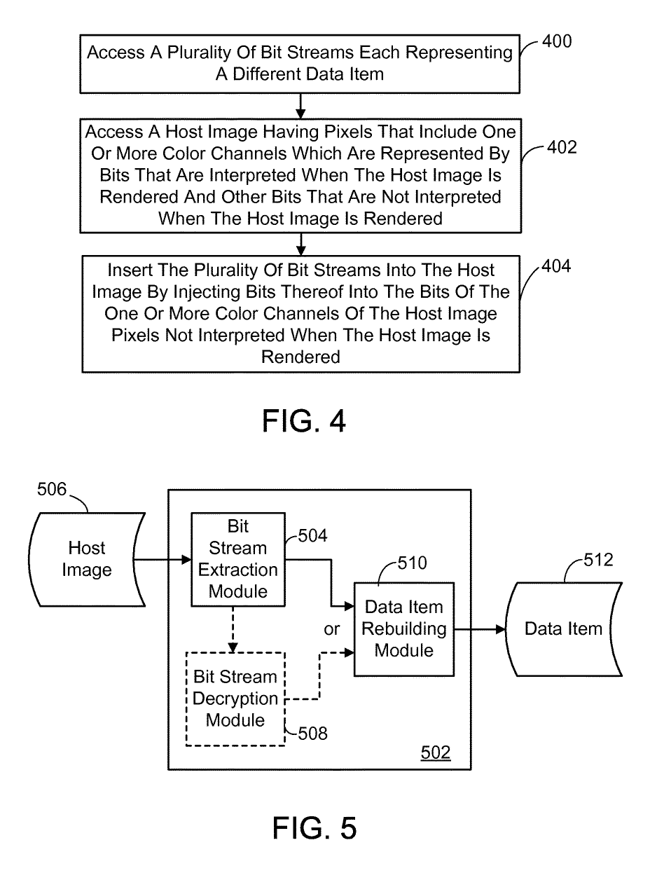

The foregoing descriptions of the image-hosted data encryption implementations involved inserting a single data item into a host image. However, multiple data items can also be inserted limited only by a host images' ability to hold more than one bit stream. More particularly, referring to FIG. 4, in one implementation the aforementioned modules (of FIG. 1) access a plurality of bit streams each representing a different data item (action 400), and access a host image having pixels that include one or more color channels which are represented by bits that are interpreted when the host image is rendered and other bits that are not interpreted when the host image is rendered (action 402). The plurality of bit streams are then inserted into the host image by injecting bits thereof into the bits of the one or more color channels of the host image pixels not interpreted when the host image is rendered (action 404).

The aforementioned various ways of reducing the number of bits in a bit stream, or expanding the number of pixels in a host image, or both can be employed to ensure that the multiple bit streams will fit in the host image. It is also noted that the data items associated with the multiple bit streams need not be the same type. Rather, they can be a combination of different types of data, such as any combination of image data, audio data, textual data, and so on.

### 2.0 Image-Hosted Data Decryption

Once a data item or items is encrypted within a host image, the host image can be stored, displayed, shared or transmitted, among other things. However, to recover the data item(s) from the host image, the bit stream associated with each data item has to be extracted and reconstructed, and in some cases decrypted, before the data item can be rebuilt. To this end, the image-hosted data encryption implementations described herein can also include the ability to decrypt an encrypted host image.

More particularly, referring to FIG. 5, in one implementation, one or more computing devices each comprising a processor, communication interface and memory are employed. If multiple computing devices are being used, they are in communication with each other via a computer network. An image-based data decrypter computer program 502 having program modules executable by the computing device or devices is also employed. These program modules include a bit stream extraction module 504 for extracting and reconstructing at least one bit stream encrypted within the host image 506. Also included is an optional bit stream decryption module 508 for decrypting each encrypted bit stream (if any). It is noted that the optional nature of the decryption module 508 is indicated by the use of a broken lines in FIG. 5. The image-based data decrypter computer program 502 further includes an data item rebuilding module 510 for converting each extracted (and possibly decrypted) bit stream back into a data item 512.

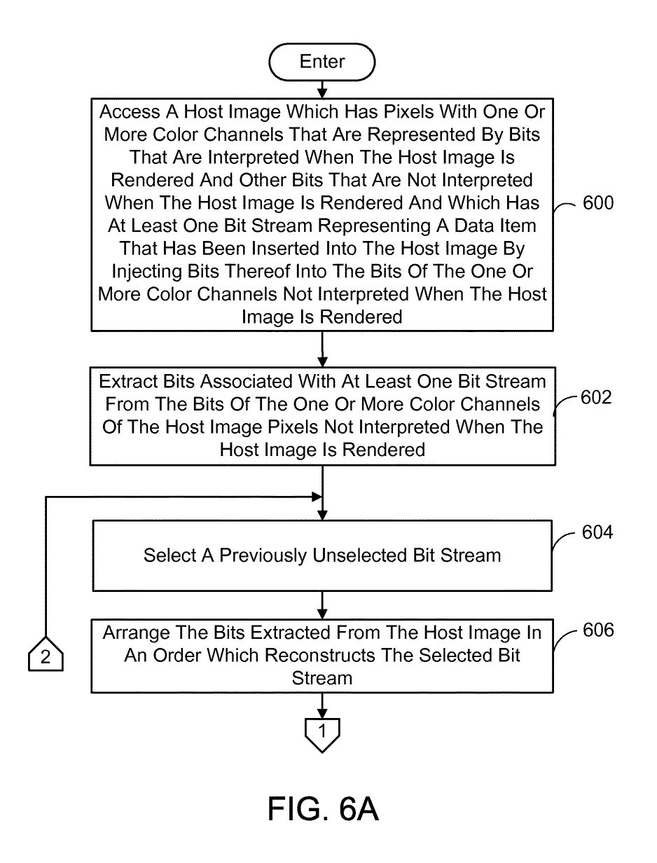

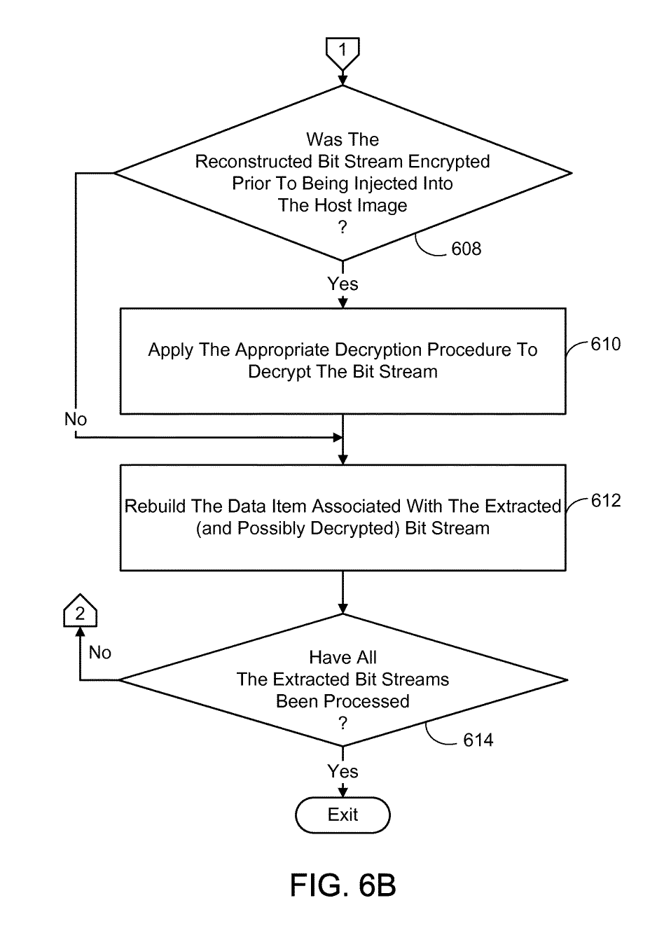

Referring now to FIGS. 6A-B, in view of the foregoing, in one implementation the aforementioned modules first access a host image which has pixels with one or more color channels that are represented by bits that are interpreted when the host image is rendered and other bits that are not interpreted when the host image is rendered and which has at least one bit stream representing a data item that has been inserted into the host image by injecting bits thereof into the bits of the one or more color channels not interpreted when the host image is rendered (action 600). Next, bits associated with at least one bit stream are extracted from the bits of the one or more color channels of the host image pixels not interpreted when the host image is rendered (action 602). In one version, this extraction removes the bits of the bit stream(s) from the aforementioned bits of the color channel or channels of the host image pixels not interpreted when the host image is rendered. Thus, the host image is returned to its original unencrypted condition. In another version, the extraction merely copies the bits of the bit stream(s), such that the host image remains in its encrypted state. Next, a previously unselected bit stream is selected (action 604), and the bits extracted from the host image are arranged in an order which reconstructs the selected bit stream (action 606). In one version, the arrangement of the extracted bits of a bit stream is done by arranging the bits in the order in which the bits were injected into the host image. In another version where the bit stream blocks were randomized before injecting them into the host image, the arrangement of the extracted bits of a bit stream involves identifying the color channels each block of the bit stream was injected into based on a knowledge of the randomizing procedure, and then reversing the previously described order in which the bit stream blocks were injected into the host image. It is then determined if the reconstructed bit stream was encrypted prior to being injected into the host image (action 608). If the bit stream was encrypted, then the appropriate decryption procedure is applied to decrypt the bit stream (action 610). The decryption procedure may be known to the image-hosted data decryption program, or if as indicated previously encryption information needed to decrypt the bit stream was added to the encrypted stream, then this information is used to identify the appropriate decryption procedure. Next, or if the bit stream was determined not to be encrypted, the data item associated with the extracted (and possibly decrypted) bit stream is rebuilt (action 612). For example, if the data item was a digital image, the image data is rebuilt from the bit stream. It is then determined if all the extracted bit streams have been processed (action 614). If not, actions 604 through 614 are repeated. Otherwise the procedure ends.

### 3.0 Deployment Scenarios

It is noted that in one implementation, the image-based data decrypter computer program is operating in isolation from the previously-described image-based data encrypter computer program. For example, the image-based data encrypter computer program can be running on a computer or computers associated with a cloud service, or a server in a server-client scenario. A user employs a computing device to communicate with the cloud service via a computer network (such as the Internet or a proprietary intranet). The data item that is to be encrypted is supplied to the cloud service which encrypts it within a host image as described previously. The host image is then provided to the user's computing device. The user can store the host image, display the host image, and transfer the host image to another computing device, as desired. In addition, the image-based data decrypter computer program is running on the user's computing device. Accordingly, the user can extract and reconstruct a bit stream from the host image as described previously, and rebuild the data item. The data item can then be displayed or played as appropriate.

In one implementation, the image-based data decrypter computer program is operating on the same computer or computers as the image-based data encrypter computer program. In one version, the two programs form part of an image-based data encrypter/decrypter application. In this scenario, a user runs the application and inputs a data item that is to be encrypted within a host image. In one version, a pre-host image such as described previously is input by the user into the application where it is transformed into a host image. In another version, the user inputs a pre-fabricated host image into the application. This host image may come from a database of such images. In such a case, the user can select the host image from the database and input it into the application. As described previously, the data item is inserted into the host image. In this scenario, the application accomplishes this task and creates an encrypted host image. The user can use the application to store the host image, display the host image, and transfer the host image to another computing device, as desired. In addition, the user can use the application to extract and reconstruct a bit stream from the host image as described previously, and rebuild the data item. The data item can then be displayed or played as appropriate.

### 4.0 Exemplary Operating Environments

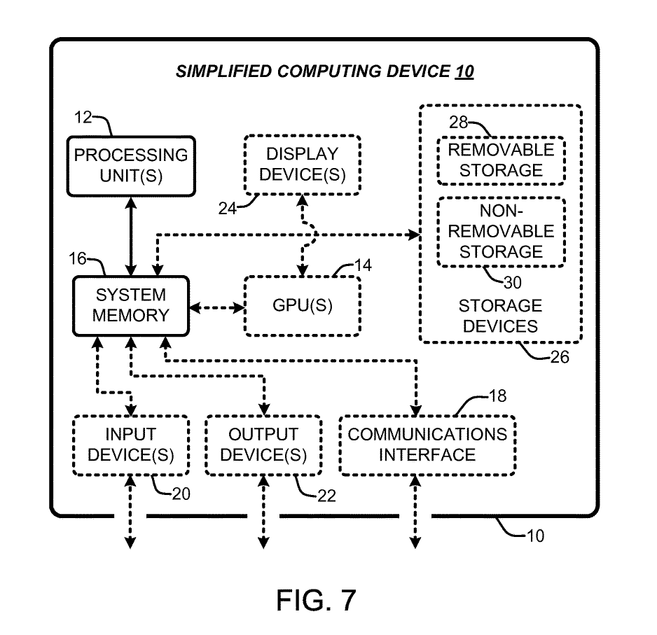

The image-hosted data encryption implementations described herein are operational using numerous types of general purpose or special purpose computing system environments or configurations. FIG. 7 illustrates a simplified example of a general-purpose computer system with which various aspects and elements of image-hosted data encryption, as described herein, may be implemented. It is noted that any boxes that are represented by broken or dashed lines in the simplified computing device 10 shown in FIG. 7 represent alternate implementations of the simplified computing device. As described below, any or all of these alternate implementations may be used in combination with other alternate implementations that are described throughout this document. The simplified computing device 10 is typically found in devices having at least some minimum computational capability such as personal computers (PCs), server computers, handheld computing devices, laptop or mobile computers, communications devices such as cell phones and personal digital assistants (PDAs), multiprocessor systems, microprocessor-based systems, set top boxes, programmable consumer electronics, network PCs, minicomputers, mainframe computers, and audio or video media players.

To realize the image-hosted data encryption implementations described herein, the device should have a sufficient computational capability and system memory to enable basic computational operations. In particular, the computational capability of the simplified computing device 10 shown in FIG. 7 is generally illustrated by one or more processing unit(s) 12, and may also include one or more graphics processing units (GPUs) 14, either or both in communication with system memory 16. Note that that the processing unit(s) 12 of the simplified computing device 10 may be specialized microprocessors (such as a digital signal processor (DSP), a very long instruction word (VLIW) processor, a field-programmable gate array (FPGA), or other micro-controller) or can be conventional central processing units (CPUs) having one or more processing cores.

In addition, the simplified computing device 10 may also include other components, such as, for example, a communications interface 18. The simplified computing device 10 may also include one or more conventional computer input devices 20 (e.g., touchscreens, touch-sensitive surfaces, pointing devices, keyboards, audio input devices, voice or speech-based input and control devices, video input devices, haptic input devices, devices for receiving wired or wireless data transmissions, and the like) or any combination of such devices.

Similarly, various interactions with the simplified computing device 10 and with any other component or feature of wearable sensing, including input, output, control, feedback, and response to one or more users or other devices or systems associated with image-hosted data encryption, are enabled by a variety of Natural User Interface (NUI) scenarios. The NUI techniques and scenarios enabled by image-hosted data encryption include, but are not limited to, interface technologies that allow one or more users user to interact in a “natural” manner, free from artificial constraints imposed by input devices such as mice, keyboards, remote controls, and the like.

Such NUI implementations are enabled by the use of various techniques including, but not limited to, using NUI information derived from user speech or vocalizations captured via microphones or other sensors. Such NUI implementations are also enabled by the use of various techniques including, but not limited to, information derived from a user's facial expressions and from the positions, motions, or orientations of a user's hands, fingers, wrists, arms, legs, body, head, eyes, and the like, where such information may be captured using various types of 2D or depth imaging devices such as stereoscopic or time-of-flight camera systems, infrared camera systems, RGB (red, green and blue) camera systems, and the like, or any combination of such devices. Further examples of such NUI implementations include, but are not limited to, NUI information derived from touch and stylus recognition, gesture recognition (both onscreen and adjacent to the screen or display surface), air or contact-based gestures, user touch (on various surfaces, objects or other users), hover-based inputs or actions, and the like. Such NUI implementations may also include, but are not limited, the use of various predictive machine intelligence processes that evaluate current or past user behaviors, inputs, actions, etc., either alone or in combination with other NUI information, to predict information such as user intentions, desires, and/or goals. Regardless of the type or source of the NUI-based information, such information may then be used to initiate, terminate, or otherwise control or interact with one or more inputs, outputs, actions, or functional features of the image-hosted data encryption implementations described herein.

However, it should be understood that the aforementioned exemplary NUI scenarios may be further augmented by combining the use of artificial constraints or additional signals with any combination of NUI inputs. Such artificial constraints or additional signals may be imposed or generated by input devices such as mice, keyboards, and remote controls, or by a variety of remote or user worn devices such as accelerometers, electromyography (EMG) sensors for receiving myoelectric signals representative of electrical signals generated by user's muscles, heart-rate monitors, galvanic skin conduction sensors for measuring user perspiration, wearable or remote biosensors for measuring or otherwise sensing user brain activity or electric fields, wearable or remote biosensors for measuring user body temperature changes or differentials, and the like. Any such information derived from these types of artificial constraints or additional signals may be combined with any one or more NUI inputs to initiate, terminate, or otherwise control or interact with one or more inputs, outputs, actions, or functional features of the image-hosted data encryption implementations described herein.

The simplified computing device 10 may also include other optional components such as one or more conventional computer output devices 22 (e.g., display device(s) 24, audio output devices, video output devices, devices for transmitting wired or wireless data transmissions, and the like). Note that typical communications interfaces 18, input devices 20, output devices 22, and storage devices 26 for general-purpose computers are well known to those skilled in the art, and will not be described in detail herein.

The simplified computing device 10 shown in FIG. 7 may also include a variety of computer-readable media. Computer-readable media can be any available media that can be accessed by the computer 10 via storage devices 26, and can include both volatile and nonvolatile media that is either removable 28 and/or non-removable 30, for storage of information such as computer-readable or computer-executable instructions, data structures, program modules, or other data. Computer-readable media includes computer storage media and communication media. Computer storage media refers to tangible computer-readable or machine-readable media or storage devices such as digital versatile disks (DVDs), blu-ray discs (BD), compact discs (CDs), floppy disks, tape drives, hard drives, optical drives, solid state memory devices, random access memory (RAM), read-only memory (ROM), electrically erasable programmable read-only memory (EEPROM), CD-ROM or other optical disk storage, smart cards, flash memory (e.g., card, stick, and key drive), magnetic cassettes, magnetic tapes, magnetic disk storage, magnetic strips, or other magnetic storage devices. Further, a propagated signal is not included within the scope of computer-readable storage media.

Retention of information such as computer-readable or computer-executable instructions, data structures, program modules, and the like, can also be accomplished by using any of a variety of the aforementioned communication media (as opposed to computer storage media) to encode one or more modulated data signals or carrier waves, or other transport mechanisms or communications protocols, and can include any wired or wireless information delivery mechanism. Note that the terms “modulated data signal” or “carrier wave” generally refer to a signal that has one or more of its characteristics set or changed in such a manner as to encode information in the signal. For example, communication media can include wired media such as a wired network or direct-wired connection carrying one or more modulated data signals, and wireless media such as acoustic, radio frequency (RF), infrared, laser, and other wireless media for transmitting and/or receiving one or more modulated data signals or carrier waves.

Furthermore, computer programs such as software, applications and/or computer program products embodying some or all of the various image-hosted data encryption implementations described herein, or portions thereof, may be stored, received, transmitted, or read from any desired combination of computer-readable or machine-readable media or storage devices and communication media in the form of computer-executable instructions or other data structures. Additionally, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, or media.

The image-hosted data encryption implementations described herein may be further described in the general context of computer-executable instructions, such as program modules, being executed by a computing device. Generally, program modules include routines, programs, objects, components, data structures, and the like, that perform particular tasks or implement particular abstract data types. The image-hosted data encryption implementations described herein may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Additionally, the aforementioned instructions may be implemented, in part or in whole, as hardware logic circuits, which may or may not include a processor.

Alternatively, or in addition, the functionality described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), and so on.

### 5.0 Other Implementations

In the foregoing descriptions of some of the image-hosted data encryption implementations, it was stated that the host image has pixels having one or more color channels that are represented by bits that include upper order bits that are not interpreted when the host image is rendered. In these implementations, the bits found in the lower order bits of each pixel's color channel(s) are interpreted and used to render an image. While this is typically the case, some image systems could interpret and render the upper order bits and ignore the lower order bits. In these latter systems, the host image has pixels having one or more color channels that are represented by bits that include lower order bits that are not interpreted when the host image is rendered. As such, the bit stream being encrypted is inserted into the host image by injecting bits thereof into the lower order bits of the one or more color channels of the host image pixels that are not interpreted when the host image is rendered. More generally, an image system could interpret and render certain bits and ignore the other bits representing a color channel of a host image pixel. In these systems, the bit stream being encrypted is inserted into the host image by injecting bits thereof into the bits of the one or more color channels of the host image pixels that are not interpreted when the host image is rendered.

It is noted that any or all of the aforementioned implementations throughout the description may be used in any combination desired to form additional hybrid implementations. In addition, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What has been described above includes example implementations. It is, of course, not possible to describe every conceivable combination of components or methodologies for purposes of describing the claimed subject matter, but one of ordinary skill in the art may recognize that many further combinations and permutations are possible. Accordingly, the claimed subject matter is intended to embrace all such alterations, modifications, and variations that fall within the spirit and scope of the appended claims.

In regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the foregoing implementations include a system as well as a computer-readable storage media having computer-executable instructions for performing the acts and/or events of the various methods of the claimed subject matter.

There are multiple ways of realizing the foregoing implementations (such as an appropriate application programming interface (API), tool kit, driver code, operating system, control, standalone or downloadable software object, or the like), which enable applications and services to use the implementations described herein. The claimed subject matter contemplates this use from the standpoint of an API (or other software object), as well as from the standpoint of a software or hardware object that operates according to the implementations set forth herein. Thus, various implementations described herein may have aspects that are wholly in hardware, or partly in hardware and partly in software, or wholly in software.

The aforementioned systems have been described with respect to interaction between several components. It will be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (e.g., hierarchical components).

Additionally, it is noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

### 6.0 Claim Support and Further Implementations

The following paragraphs summarize various examples of implementations which may be claimed in the present document. However, it should be understood that the implementations summarized below are not intended to limit the subject matter which may be claimed in view of the foregoing descriptions. Further, any or all of the implementations summarized below may be claimed in any desired combination with some or all of the implementations described throughout the foregoing description and any implementations illustrated in one or more of the figures, and any other implementations described below. In addition, it should be noted that the following implementations are intended to be understood in view of the foregoing description and figures described throughout this document.

In one implementation, a system for encrypting data within a host image includes one or more computing devices each including a processor, communication interface and memory. If there are multiple computing devices, they are in communication with each other via a computer network. The system also includes a computer program having program modules executable by the one or more computing devices. The one or more computing devices are directed by the program modules of the computer program to: access a bit stream representing a data item; access a host image which has pixels including one or more color channels that are represented by bits that are interpreted when the host image is rendered and other bits that are not interpreted when the host image is rendered; and insert the bit stream into the host image by injecting bits thereof into the bits of the one or more color channels of the host image pixels that are not interpreted when the host image is rendered. In one version, accessing the bit stream representing the data item includes receiving the data item and generating a bit stream from the data item. In one version, accessing the host image includes receiving the pre-host image including one or more color channels for each pixel, each channel of which has an 8-bit digital value representing a color level for that channel, and transforming the received pre-host image into a host image so that one or more of the color channels of the pixels of the host image are represented by more bits than the pixels of the original pre-host image, wherein the upper order bits represent the added bits and are not interpreted when the transformed image is rendered. Transforming the received pre-host image into a host image can include adding a sufficient number upper order bits to the one or more of the color channels of the pixels to allow insertion of the entirety of the data item bit stream in the added upper order bits. Accessing the host image can include scaling the host image up to increase the number of pixels to a sufficient number having one or more of the color channels with upper order bits not interpreted when the host image is rendered to insert the entirety of the data item bit stream in the upper order bits of the scaled host image pixels. Further, accessing the host image can include selecting the host image from a plurality of host images, the selecting involving selecting a host image that has a sufficient number of pixels with one or more of the color channels having upper order bits not interpreted when the host image is rendered to insert the entirety of the data item bit stream in the upper order bits of the selected host image pixels. Still further, accessing the host image can include selecting the host image from a plurality of host images, and scaling the selected host image up to increase the number of pixels to a sufficient number having one or more of the color channels with upper order bits not interpreted when the host image is rendered to insert the entirety of the data item bit stream in the upper order bits of the scaled host image pixels. In one version, the host image is in a JPEG-XR format, wherein the JPEG-XR format employs two bytes for each color channel of each pixel with the upper order byte not being interpreted when rendered. In one version, accessing the bit stream representing the data item includes: receiving the data item; removing a portion of the data from the data item; and generating a bit stream from the remaining portion of the data item; where the number of bits in the generated bit stream does not exceed the number of bits that can be inserted into upper order bits of the one or more of the color channels of the host image pixels not interpreted when the host image is rendered. The data item can be an image, and removing a portion of the data from the data item involves cropping a portion of the image. In one version, accessing the bit stream representing the data item includes compressing the bit stream using a data compression method to an extent that the number of bits in the compressed bit stream does not exceed the number of bits that can be inserted into upper order bits of the one or more of the color channels of the host image pixels not interpreted when the host image is rendered. In one version, prior to inserting the bit stream into the host image, the bit stream is encrypted using an encryption method.

In one implementation, a system for encrypting data within a host image includes one or more computing devices each including a processor, communication interface and memory. If there are multiple computing devices, they are in communication with each other via a computer network. The system also includes a computer program having program modules executable by the one or more computing devices. The one or more computing devices are directed by the program modules of the computer program to: access a plurality of bit streams each representing a different data item; access a host image which has pixels including one or more color channels that are represented by bits that are interpreted when the host image is rendered and other bits that are not interpreted when the host image is rendered; and insert the plurality of bit streams into the host image by injecting bits thereof into the upper order bits of the one or more color channels of the host image pixels that are not interpreted when the host image is rendered. In one version, accessing the host image includes receiving a pre-host image, the pre-host image including one or more color channels for each pixel, each channel of which has an 8-bit digital value representing a color level for that channel, and transforming the received pre-host image into the host image so that one or more of the color channels of pixels of the host image are represented by more bits than the pixels of the pre-host image, where the upper order bits represent the added bits and are not interpreted when the transformed image is rendered, and where the host image has a sufficient number of pixels to insert the entirety of the plurality of bit streams in the added upper order bits of the transformed host image pixels. In another version, accessing the host image includes selecting the host image from a plurality of host images, the selecting involving selecting a host image that has a sufficient number of pixels with one or more of the color channels having upper order bits not interpreted when the host image is rendered to insert the entirety of the plurality of bit streams in the upper order bits of the selected host image pixels. In one version, accessing the plurality of bit streams each representing a different data item, includes: receiving the data items; removing a portion of the data from one or more of the data items; and generating a separate bit stream from the remaining portion of each data item; where the total number of bits in the generated bit streams does not exceed the number of bits that can be inserted into upper order bits of the one or more of the color channels of the host image pixels not interpreted when the host image is rendered. In another version, accessing the plurality of bit streams each representing a different data item, includes compressing one or more of the bit streams using a data compression method to an extent that the total number of bits in the resulting bit streams does not exceed the number of bits that can be inserted into upper order bits of the one or more of the color channels of the host image pixels not interpreted when the host image is rendered.

In one implementation, a system for decrypting data inserted into a host image includes one or more computing devices each including a processor, communication interface and memory. If there are multiple computing devices, they are in communication with each other via a computer network. The system also includes a computer program having program modules executable by the one or more computing devices. The one or more computing devices are directed by the program modules of the computer program to: access a host image which has pixels including one or more color channels that are represented by bits that are interpreted when the host image is rendered and other bits that are not interpreted when the host image is rendered and which has at least one bit stream representing a data item that has been inserted into the host image by injecting bits thereof into the bits of the one or more color channels of the host image pixels not interpreted when the host image is rendered; extract bits associated with at least one bit stream from the bits of the one or more color channels of the host image pixels not interpreted when the host image is rendered; and for each bit stream whose bits have been extracted, arrange the extracted bits in an order which reconstructs the bit stream, and rebuild the data item associated with the bit stream. In one version, arranging the extracted bits in an order which reconstructs the bit stream, involves arranging the extracted bits in an order in which the bits were injected into the host image. In one version where at least one bit stream was encrypted using an encryption method prior to being injected into the host image, the computer program further includes a program module for, prior to executing the program module for rebuilding the data item associated with an encrypted bit stream, applying a decryption method appropriate for the encryption method to decrypt the bit stream.

As indicated previously, the implementations and versions described in any of the previous paragraphs in this section may also be combined with each other, and with one or more of the implementations and versions described prior to this section. For example, encrypting the bit stream prior to inserting the bit stream into the host image, can be combined any of the foregoing ways of accessing a bit stream representing a data item and accessing a host image.

In one implementation, encrypting data within a host image includes using a computing device to perform the following process steps: a bit stream accessing step for accessing one or more bit streams each representing a data item; a host image accessing step for accessing a host image which has pixels including one or more color channels that are represented by bits that are interpreted when the host image is rendered and other bits that are not interpreted when the host image is rendered; and a bit stream insertion step for inserting the one or more bit streams into the host image by injecting bits thereof into the bits of the one or more color channels of the host image pixels that are not interpreted when the host image is rendered.

In one implementation, decrypting data inserted into a host image includes using a computing device to perform the following process steps: a host image accessing step for accessing a host image which has pixels including one or more color channels that are represented by bits that are interpreted when the host image is rendered and other bits that are not interpreted when the host image is rendered and which has at least one bit stream representing a data item that has been inserted into the host image by injecting bits thereof into the bits of the one or more color channels of the host image pixels not interpreted when the host image is rendered; an extracting step for extracting bits associated with at least one bit stream from the bits of the one or more color channels of the host image pixels not interpreted when the host image is rendered; and for each bit stream whose bits have been extracted, an arrangement step for arranging the extracted bits in an order which reconstructs the bit stream, and rebuilds the data item associated with the bit stream.

Wherefore, what is claimed is:

1. A system for encrypting data within a host image, comprising:
one or more computing devices each comprising a processor, communication interface and memory, wherein said computing devices are in communication with each other via a computer network whenever there are multiple computing devices; and
a computer program having program modules executable by the computing device or devices, the computing device or devices being directed by the program modules of the computer program to,
access a bit stream representing a data item;
access a host image which has pixels comprising one or more color channels that are represented by bits that are interpreted when the host image is rendered and other bits that are not interpreted when the host image is rendered; and
insert the bit stream into the host image by injecting bits thereof into the bits of the one or more color channels of the host image pixels that are not interpreted when the host image is rendered.

2. The system of claim 1, wherein the program module for accessing the bit stream representing the data item, comprises sub-modules for:
receiving the data item; and
generating a bit stream from the data item.

3. The system of claim 1, wherein the program module for accessing the host image, comprises sub-modules for:
receiving the pre-host image comprising one or more color channels for each pixel, each channel of which has an 8-bit digital value representing a color level for that channel; and
transforming the received pre-host image into a host image so that one or more of the color channels of the pixels of the host image are represented by more bits than the pixels of the original pre-host image, wherein the upper order bits represent the added bits and are not interpreted when the transformed image is rendered.

4. The system of claim 3, wherein the sub-module for transforming the received pre-host image into a host image comprises adding a sufficient number upper order bits to the one or more of the color channels of the pixels to allow insertion of the entirety of the data item bit stream in said added upper order bits.

5. The system of claim 3, wherein the program module for accessing the host image, further comprises a sub-module for scaling the host image up to increase the number of pixels to a sufficient number having one or more of the color channels with upper order bits not interpreted when the host image is rendered to insert the entirety of the data item bit stream in said upper order bits of the scaled host image pixels.

6. The system of claim 1, wherein the program module for accessing the host image, comprises a sub-module for selecting the host image from a plurality of host images, said selecting comprising selecting a host image that has a sufficient number of pixels with one or more of the color channels having upper order bits not interpreted when the host image is rendered to insert the entirety of the data item bit stream in said upper order bits of the selected host image pixels.

7. The system of claim 1, wherein the program module for accessing the host image, comprises sub-modules for:
selecting the host image from a plurality of host images; and
scaling the selected host image up to increase the number of pixels to a sufficient number having one or more of the color channels with upper order bits not interpreted when the host image is rendered to insert the entirety of the data item bit stream in said upper order bits of the scaled host image pixels.

8. The system of claim 1, wherein the host image is in a JPEG-XR format, wherein said JPEG-XR format employs two bytes for each color channel of each pixel with the upper order byte not being interpreted when rendered.

9. The system of claim 1, wherein the program module for accessing the bit stream representing the data item, comprises sub-modules for:
receiving the data item;
removing a portion of the data from the data item; and
generating a bit stream from the remaining portion of the data item; wherein
the number of bits in the generated bit stream does not exceed the number of bits that can be inserted into upper order bits of the one or more of the color channels of the host image pixels not interpreted when the host image is rendered.

10. The system of claim 9, wherein the data item is an image, and wherein the sub-module for removing a portion of the data from the data item, comprises cropping a portion of the image.

11. The system of claim 1, wherein the program module for accessing the bit stream representing the data item, comprises a sub-module for compressing the bit stream using a data compression method to an extent that the number of bits in the compressed bit stream does not exceed the number of bits that can be inserted into upper order bits of the one or more of the color channels of the host image pixels not interpreted when the host image is rendered.

12. The system of claim 1, further comprising a program module, executed prior to executing the program module for inserting the bit stream into the host image, for encrypting the bit stream using an encryption method.

13. A system for encrypting data within a host image, comprising:
one or more computing devices each comprising a processor,
communication interface and memory, wherein said computing devices are in communication with each other via a computer network whenever there are multiple computing devices; and
a computer program having program modules executable by the computing device or devices, the computing device or devices being directed by the program modules of the computer program to,
access a plurality of bit streams each representing a different data item;
access a host image which has pixels comprising one or more color channels that are represented by bits that are interpreted when the host image is rendered and other bits that are not interpreted when the host image is rendered; and
insert the plurality of bit streams into the host image by injecting bits thereof into the upper order bits of the one or more color channels of the host image pixels that are not interpreted when the host image is rendered.

14. The system of claim 13, wherein the program module for accessing the host image, comprises sub-modules for:
receiving a pre-host image, said pre-host image comprising one or more color channels for each pixel, each channel of which has an 8-bit digital value representing a color level for that channel; and
transforming the received pre-host image into the host image so that one or more of the color channels of pixels of the host image are represented by more bits than the pixels of the pre-host image, wherein the upper order bits represent the added bits and are not interpreted when the transformed image is rendered, and wherein the host image has a sufficient number of pixels to insert the entirety of the plurality of bit streams in said added upper order bits of the transformed host image pixels.

15. The system of claim 13, wherein the program module for accessing the host image, comprises a sub-module for selecting the host image from a plurality of host images, said selecting comprising selecting a host image that has a sufficient number of pixels with one or more of the color channels having upper order bits not interpreted when the host image is rendered to insert the entirety of the plurality of bit streams in said upper order bits of the selected host image pixels.

16. The system of claim 13, wherein the program module for accessing the plurality of bit streams each representing a different data item, comprises sub-modules for:
receiving the data items;
removing a portion of the data from one or more of the data items; and
generating a separate bit stream from the remaining portion of each data item; wherein
the total number of bits in the generated bit streams does not exceed the number of bits that can be inserted into upper order bits of the one or more of the color channels of the host image pixels not interpreted when the host image is rendered.

17. The system of claim 13, wherein the program module for accessing the plurality of bit streams each representing a different data item, comprises a sub-module for compressing one or more of the bit streams using a data compression method to an extent that the total number of bits in the resulting bit streams does not exceed the number of bits that can be inserted into upper order bits of the one or more of the color channels of the host image pixels not interpreted when the host image is rendered.

18. A system for decrypting data inserted into a host image, comprising:
one or more computing devices each comprising a processor, communication interface and memory, wherein said computing devices are in communication with each other via a computer network whenever there are multiple computing devices; and
a computer program having program modules executable by the computing device or devices, the computing device or devices being directed by the program modules of the computer program to,
access a host image which has pixels comprising one or more color channels that are represented by bits that are interpreted when the host image is rendered and other bits that are not interpreted when the host image is rendered and which has at least one bit stream representing a data item that has been inserted into the host image by injecting bits thereof into the bits of the one or more color channels of the host image pixels not interpreted when the host image is rendered,
extract bits associated with at least one bit stream from the bits of the one or more color channels of the host image pixels not interpreted when the host image is rendered, and
for each bit stream whose bits have been extracted,
arrange the extracted bits in an order which reconstructs the bit stream, and
rebuild the data item associated with the bit stream.

19. The system of claim 18, wherein the program module for arranging the extracted bits in an order which reconstructs the bit stream, comprises a sub-module for arranging the extracted bits in an order in which the bits were injected into the host image.

20. The system of claim 18, wherein at least one bit stream was encrypted using an encryption method prior to being injected into the host image, and wherein the computer program further comprises a program module for, prior to executing the program module for rebuilding the data item associated with an encrypted bit stream, applying a decryption method appropriate for said encryption method to decrypt the bit stream.
